(19) United States
(12) Patent Application Publication
(10) Pub. No.: US 2025/0209768 A1
(43) Pub. Date: Jun. 26, 2025

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventors: Koichi TANAKA, Saitama (JP); Kazuma TSUKAGOSHI, Saitama (JP); Kazuya OKIYAMA, Saitama (JP); Mototada OTSURU, Saitama (JP)

(73) Assignee: FUJIFILM Corporation, Tokyo (JP)

(21) Appl. No.: 19/078,249

(22) Filed: Mar. 12, 2025

Related U.S. Application Data
(63) Continuation of application No. PCT/JP2023/033649, filed on Sep. 15, 2023.

(30) Foreign Application Priority Data
Sep. 30, 2022 (JP) 2022-157584

(51) Int. Cl. G06T 19/20

(52) U.S. Cl. CPC G06T 19/20; G06T 2219/2004; G06T 2219/2016

(57) ABSTRACT

Provided are an image processing apparatus, an image processing method, and an image processing program that can provide a good image viewing space. An image processing apparatus acquires position information in a virtual space that reproduces a real space, displays, based on a first image associated with the position information and captured in the real space, an object image representing the first image in the virtual space, and displays a second image of the virtual space observed from a viewpoint corresponding to the position information on a display unit.

### CROSS-REFERENCE TO RELATED APPLICATIONS

The present application is a Continuation of PCT International Application No. PCT/JP2023/033649 filed on Sep. 15, 2023 claiming priority under 35 U.S.C § 119 (a) to Japanese Patent Application No. 2022-157584 filed on Sep. 30, 2022. Each of the above applications is hereby expressly incorporated by reference, in its entirety, into the present application.

### BACKGROUND OF THE INVENTION

### 1. Field of the Invention

The present invention relates to an image processing apparatus, an image processing method, and an image processing program, and particularly relates to an image processing apparatus, an image processing method, and an image processing program for providing a virtual space.

### 2. Description of the Related Art

JP2009-296248A, JP2011-186565A, JP2012-252716A, and JP2022-68642A disclose a technique of viewing, in a virtual space, an image captured in a real space.

### SUMMARY OF THE INVENTION

One embodiment according to the technology of the present disclosure provides an image processing apparatus, an image processing method, and an image processing program that can provide a good image viewing space.
(1) An image processing apparatus comprising: a processor, in which the processor is configured to acquire position information in a virtual space that reproduces a real space, display, based on a first image associated with the position information and captured in the real space, an object image representing the first image in the virtual space, and display a second image of the virtual space observed from a viewpoint corresponding to the position information on a display unit.
(2) The image processing apparatus according to (1), in which the processor is configured to make a change to the virtual space corresponding to image information of the first image.
(3) The image processing apparatus according to (1) or (2), in which the first image is an image captured within a range of a first distance from a position in the real space corresponding to the position information in the virtual space.
(4) The image processing apparatus according to (3), in which the first image is further an image captured within a range in the real space corresponding to a range of the second image in the virtual space.
(5) The image processing apparatus according to any one of (1) to (4), in which the processor is configured to display the object image at a position in the virtual space corresponding to a position in the real space where the first image is captured.
(6) The image processing apparatus according to (2), in which the processor is configured to make a change to the virtual space corresponding to the image information of the first image in a case in which a position indicated by the position information is moved to a position within a range of a second distance from a display position of the object image.
(7) The image processing apparatus according to any one of (1) to (6), in which the processor is configured to display the object image in an orientation in which the first image is captured.
(8) The image processing apparatus according to any one of (1) to (7), in which the processor is configured to display the object image at a size corresponding to an angle of view of the first image.
(9) The image processing apparatus according to any one of (1) to (7), in which the processor is configured to, in a case in which the angle of view of the first image exceeds a threshold value, display the object image at a size corresponding to the angle of view, and display the object image at a specified size in a case in which the angle of view of the first image is equal to or less than the threshold value.
(10) The image processing apparatus according to (2), in which the processor is configured to determine an imaging environment of the first image based on the image information of the first image, and make a change to the virtual space corresponding to the determined imaging environment.
(11) The image processing apparatus according to (10), in which the processor is configured to determine at least one of a season, weather, or time of day as the imaging environment.
(12) The image processing apparatus according to (2), (10), or (11), in which the processor is configured to make a change to virtual space data for constructing a different virtual space.
(13) The image processing apparatus according to (2), (10), (11), or (12), in which the processor is configured to apply an effect to change the virtual space.
(14) The image processing apparatus according to (2), (10), (11), (12), or (13), in which the processor is configured to display a plurality of the object images in the virtual space in a case in which a plurality of the first images are present, receive selection of the object image, and make a change to the virtual space corresponding to the image information of the first image represented by the selected object image.
(15) The image processing apparatus according to (14), in which the processor is configured to receive the selection of the object image by regarding the object image present in a visual line direction as the selected object image.
(16) The image processing apparatus according to (2), (10), (11), (12), (13), (14), or (15), in which the first image is an image captured within a range of a first distance from a position in the real space corresponding to the position information in the virtual space.
(17) The image processing apparatus according to (16), in which the first image is further an image captured within a range in the real space corresponding to a range of the second image in the virtual space.
(18) The image processing apparatus according to (2), (10), (11), (12), (13), (14), (15), (16), or (17), in which the processor is configured to display the object image being selected and the other object image in different display aspects.
(19) An image processing method comprising: a step of acquiring position information in a virtual space that reproduces a real space; a step of displaying, based on a first image associated with the position information and captured in the real space, an object image representing the first image in the virtual space; and a step of displaying a second image of the virtual space observed from a viewpoint corresponding to the position information on a display unit.
(20) An image processing program causing a computer to implement: a function of acquiring position information in a virtual space that reproduces a real space; a function of displaying, based on a first image associated with the position information and captured in the real space, an object image representing the first image in the virtual space; and a function of displaying a second image of the virtual space observed from a viewpoint corresponding to the position information on a display unit.

### BRIEF DESCRIPTION OF THE DRAWINGS

FIG. 1 is a diagram showing an outline of an image viewing system.

FIG. 2 is a diagram showing an example of a system configuration of the image viewing system.

FIG. 3 is a block diagram showing an example of a configuration of a display terminal.

FIG. 4 is a block diagram of main functions of a control unit of the display terminal.

FIG. 5 is a diagram showing an example of a hardware configuration of an image processing apparatus.

FIG. 6 is a block diagram of main functions of the image processing apparatus.

FIG. 7 is a conceptual diagram of image search.

FIG. 8 is a diagram showing an example of virtual space data stored in a virtual space database.

FIG. 9 is a diagram showing an example of an image of a virtual space displayed on a display unit of the display terminal.

FIG. 10 is a flowchart showing a procedure of providing a virtual space using the image processing apparatus.

FIG. 11 is a flowchart showing a procedure of providing a virtual space using the image processing apparatus.

FIGS. 12A and 12B are conceptual diagrams of display of a captured image.

FIG. 13 is a flowchart showing a procedure of processing of displaying a captured image.

FIGS. 14A and 14B are conceptual diagrams of display of a captured image.

FIG. 15 is a flowchart showing a procedure of processing of displaying a captured image.

FIG. 16 is a diagram showing another example of display of a captured image.

FIG. 17 is a diagram showing still another example of display of a captured image.

FIG. 18 is a block diagram of main functions of the image processing apparatus with respect to a change in the virtual space.

FIG. 19 is a conceptual diagram of determination of a captured image being viewed.

FIG. 20 is a flowchart of a procedure of processing related to a change in the virtual space.

FIG. 21 is a flowchart showing a procedure of imaging environment determination processing.

FIG. 22 is a conceptual diagram of determination of a captured image being viewed.

FIG. 23 is a diagram showing an example of an image selection operation of a user.

FIG. 24 is a diagram showing another example of display of a captured image in the virtual space.

FIG. 25 is a diagram showing still another example of display of a captured image in the virtual space.

### DESCRIPTION OF THE PREFERRED EMBODIMENTS

Hereinafter, preferred embodiments of the present invention will be described with reference to the accompanying drawings.

### First Embodiment

In recent years, social networking services (SNS) have been widely used, and images captured at tourist spots and the like are made public on a time axis close to real time. Therefore, a state of the site can be indirectly confirmed by viewing these images without actually visiting the tourist spot.

On the other hand, in recent years, with the development of technologies such as virtual reality (VR), augmented reality (AR), and mixed reality (MR), a digital twin, which reproduces a real space (actual space, existing space) in a virtual space, is becoming a reality.

In the present disclosure, a new image viewing system using a digital twin is provided.

### [Outline]

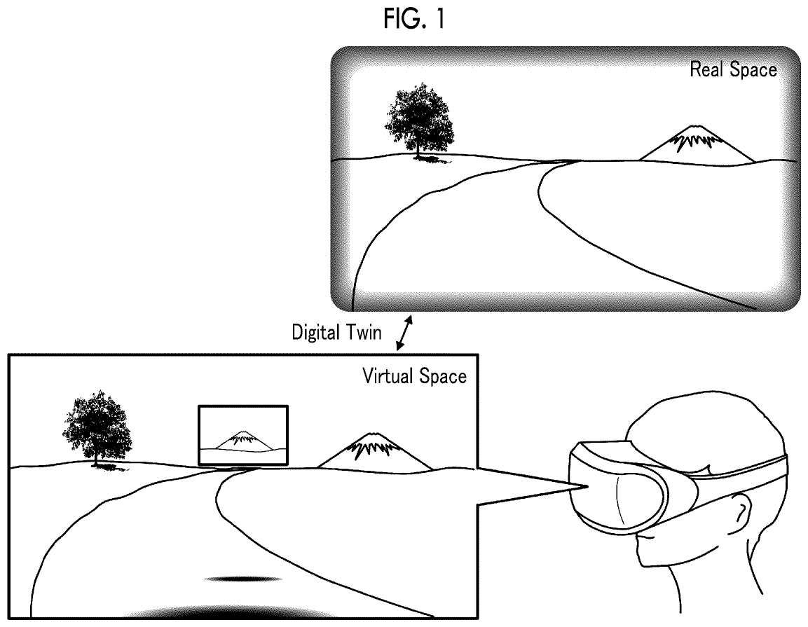

FIG. 1 is a diagram showing an outline of the image viewing system of the present disclosure.

For example, a virtual space that reproduces a real space such as a tourist spot is provided to a user via a head mounted display (HMD) or the like. The user can freely move in the virtual space as in the real space. In a case in which an image captured in the real space is present, in a case in which the user approaches a position in the virtual space corresponding to a position in the real space where the image is captured, the image is displayed in the virtual space.

### [Image Viewing System]

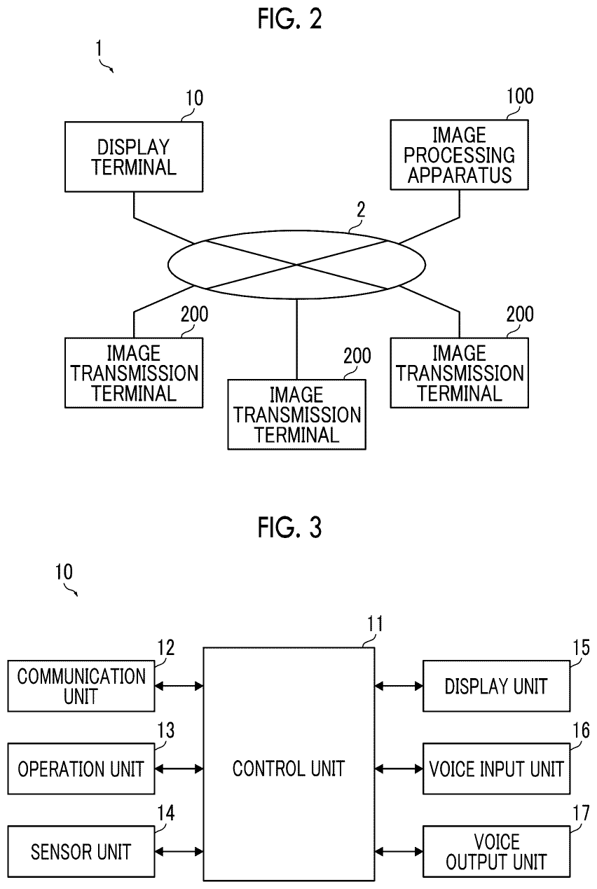

FIG. 2 is a diagram showing an example of a system configuration of the image viewing system.

As shown in FIG. 2, an image viewing system 1 of the present embodiment includes a display terminal 10 that displays an image of a virtual space, an image processing apparatus 100 that provides the image of the virtual space to the display terminal 10, and an image transmission terminal 200 that transmits an image captured in a real space to the image processing apparatus 100. The display terminal 10 and the image processing apparatus 100 are communicably connected via a network 2. In addition, the image transmission terminal 200 and the image processing apparatus 100 are communicably connected via the network 2.

### [Image Transmission Terminal]

The image transmission terminal 200 is configured of, for example, a computer (for example, a personal computer) having a communication function, a portable terminal (for example, a smartphone, a mobile phone, or a tablet terminal), and an imaging device (for example, a digital camera) having a communication function. These configurations themselves are known, so that detailed description thereof will be omitted.

As described above, the image transmission terminal 200 transmits (uploads) an image captured in the real space to the image processing apparatus 100. The image to be transmitted may be captured by another device. In a case in which the image transmission terminal itself has an imaging function (for example, a smartphone with a camera function), an image captured by the image transmission terminal itself can be transmitted to the image processing apparatus 100.

At least information (imaging position information) indicating an imaging position is attached to the image transmitted from the image transmission terminal 200 to the image processing apparatus 100. The imaging position information is composed of information for uniquely specifying a position in the real space. For example, the imaging position information can be composed of information on latitude and longitude of a location where imaging is performed. The imaging position information can further include information on altitude. It is preferable that, in addition to the imaging position information, information (imaging date and time information) indicating an imaging date and time, information (imaging direction information) indicating an imaging direction (direction in which imaging is performed, direction of an optical axis), and the like are attached to the image.

The form in which the imaging position information and the like are attached to the image is not particularly limited. For example, it can be attached to the image as metadata. In a device that records an image in an exchangeable image file format (EXIF), the imaging position information and the like can be attached to the image as tag information. In particular, in a digital camera with a global positioning system (GPS), a portable terminal, or the like, GPS information (latitude, longitude, altitude, and the like) at the time of imaging is automatically added to the captured image as the imaging position information. In addition, in a digital camera with an electronic compass (geomagnetic sensor), a portable terminal, or the like, information on a direction in which imaging is performed is automatically added as the imaging direction information.

### [Display Terminal]

In the present embodiment, the display terminal 10 is configured of, for example, a non-transparent HMD that is worn on a head of the user and that covers a visual field of the user with a display unit. By configuring the HMD to block the outside world in a case in which the HMD is worn on the head, it is possible to increase the sense of virtual reality and immersion during viewing.

FIG. 3 is a block diagram showing an example of a configuration of the display terminal.

As shown in FIG. 3, the display terminal 10 includes a control unit 11, a communication unit 12, an operation unit 13, a sensor unit 14, a display unit 15, a voice input unit 16, and a voice output unit 17.

The control unit 11 functions as a calculation processing device and a control device, and controls the overall operation of the display terminal 10 in accordance with various programs. The control unit 11 is configured of, for example, a computer comprising a processor and a memory. The processor is configured by an electronic circuit such as a central processing unit (CPU). The memory includes a read only memory (ROM) that stores a program, various data, and the like, a random access memory (RAM) that is used as a work area or the like, a flash memory, and the like.

The communication unit 12 is connected to the network 2 in a wired or wireless manner, and communicates with the image processing apparatus 100 on the network. The communication unit 12 is communicatively connected to the network 2 via, for example, a wired/wireless LAN (local area network), or Wi-Fi (registered trademark), Bluetooth (registered trademark), a mobile communication network 5th generation (5G/fifth generation mobile communication system), a mobile communication network 4th generation (4G/fourth generation mobile communication system), or LTE (long term evolution).

The operation unit 13 receives an operation instruction from the user and outputs the operation content to the control unit 11. In the present embodiment, movement in the virtual space is performed by operating the operation unit 13. The movement operation can be performed, for example, by an operation device capable of inputting a direction. For example, a hand controller or a joystick can be employed. In addition, the operation unit 13 can include known operation devices such as a push switch, a lever, a volume, a pedal switch, a keyboard, a mouse, a track pad, a track ball, and a gesture input device.

The sensor unit 14 detects at least an inclination (inclination of three axes XYZ) of a headset or goggles (part worn on the head) (three degrees of freedom; 3DoF). That is, an orientation of the head is detected. The sensor unit 14 may further detect a position of the headset or the goggles in a three-dimensional space (six degrees of freedom; 6 DoF). That is, in addition to the orientation, a position of the head is detected. This type of sensing technology is known, so that detailed description thereof will be omitted. As an example, a configuration can be employed in which a gyro sensor, an acceleration sensor, a geomagnetic sensor, or the like is used to detect the inclination of the headset or the goggles and the position in the three-dimensional space. The sensor unit 14 may also include a biosensor that detects biological information of the user (for example, a pulse, a heart rate, sweating, a blood pressure, a body temperature, breathing, a myoelectric value, and a brainwave), a visual line detection sensor that detects a visual line of the user inside the headset or the goggles, and the like. Sensing information detected by the sensor unit 14 is output to the control unit 11.

In a case in which the display terminal 10 is configured of an HMD, the display unit 15 comprises a screen for a left eye and a screen for a right eye corresponding to left and right eyes of the user, and displays images (a left eye image and a right eye image) corresponding to the respective screens. The screen of the display unit 15 is configured of, for example, a display panel such as a liquid crystal display (LCD) or an organic light emitting diode (OLED) display, or a laser scanning type display such as a direct retinal imaging display.

The voice input unit 16 is configured of, for example, a microphone, and collects a voice uttered by the user.

The voice output unit 17 is configured of, for example, headphones or earphones, and reproduces a voice signal.

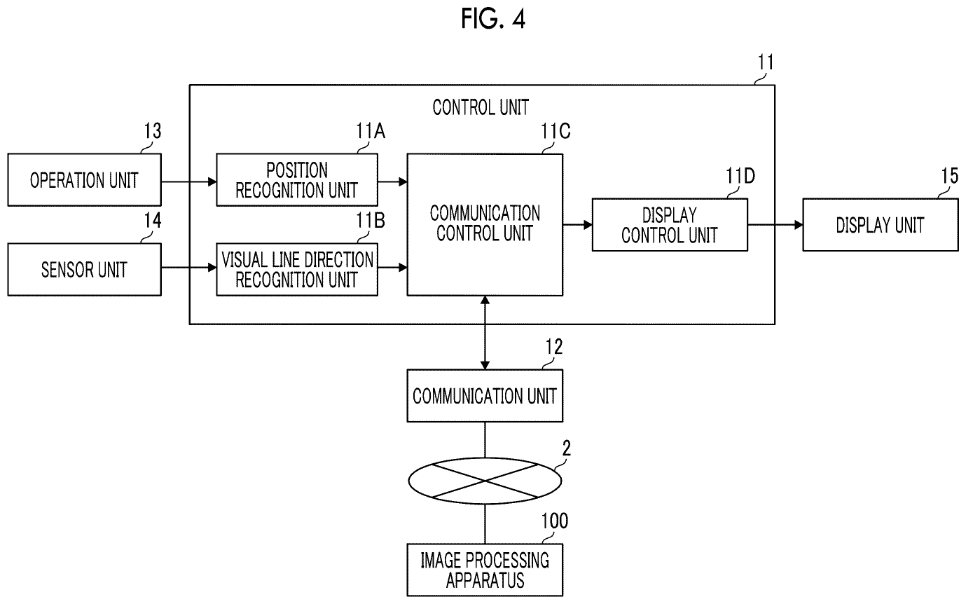

FIG. 4 is a block diagram of main functions of the control unit of the display terminal.

As shown in FIG. 4, the control unit 11 of the display terminal 10 functions as a position recognition unit 11A, a visual line direction recognition unit 11B, a communication control unit 11C, a display control unit 11D, and the like.

The position recognition unit 11A recognizes a current position (user position) of the user in the virtual space based on operation information of the operation unit 13. For example, the user position is recognized from a movement direction and a movement amount from an origin position set in the virtual space. The positions in the virtual space correspond to the positions in the real space on a one-to-one basis.

The visual line direction recognition unit 11B recognizes a current visual line direction of the user in the virtual space based on the state (orientation, position, and the like) of the head detected by the sensor unit 14.

The communication control unit 11C controls communication with the image processing apparatus 100. The current position information of the user (user position information) recognized by the position recognition unit 11A and the information on the current visual line direction of the user (user visual line information) recognized by the visual line direction recognition unit are transmitted to the image processing apparatus 100 via the communication unit 12 under the control of the communication control unit 11C. As will be described below, the image processing apparatus 100 generates an image to be displayed on the display unit 15 based on the information transmitted from the display terminal 10. The communication control unit 11C receives the image for display transmitted from the image processing apparatus 100 via the communication unit 12.

The display control unit 11D controls the display of the display unit 15. The image for display received from the image processing apparatus 100 is displayed on the display unit 15 under the control of the display control unit 11D.

### [Image Processing Apparatus]

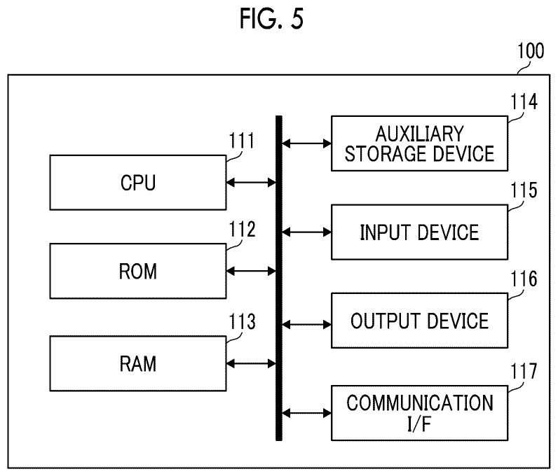

FIG. 5 is a diagram showing an example of a hardware configuration of the image processing apparatus.

As shown in FIG. 5, the image processing apparatus 100 comprises a CPU 111, a ROM 112, a RAM 113, an auxiliary storage device 114, an input device 115, an output device 116, a communication interface (I/F) 117, and the like. In general, this type of configuration is achievable on a computer.

The image processing apparatus 100 functions as an image processing apparatus in a case in which the CPU 111, which is a processor, executes a predetermined program (image processing program). The program executed by the CPU 111 is stored in the ROM 112 or the auxiliary storage device 114.

The auxiliary storage device 114 constitutes a storage unit of the image processing apparatus 100. The auxiliary storage device 114 is configured of, for example, a hard disk drive (HDD) and a solid state drive (SSD).

The input device 115 constitutes an operation unit of the image processing apparatus 100. The input device 115 is configured of, for example, a keyboard, a mouse, and a touch panel.

The output device 116 constitutes a display unit of the image processing apparatus 100. The output device 116 is configured of, for example, a LCD and an OLED display.

The communication interface 117 is connected to the network 2 in a wired or wireless manner, and communicates with display terminal 10 and the image transmission terminal 200 on the network.

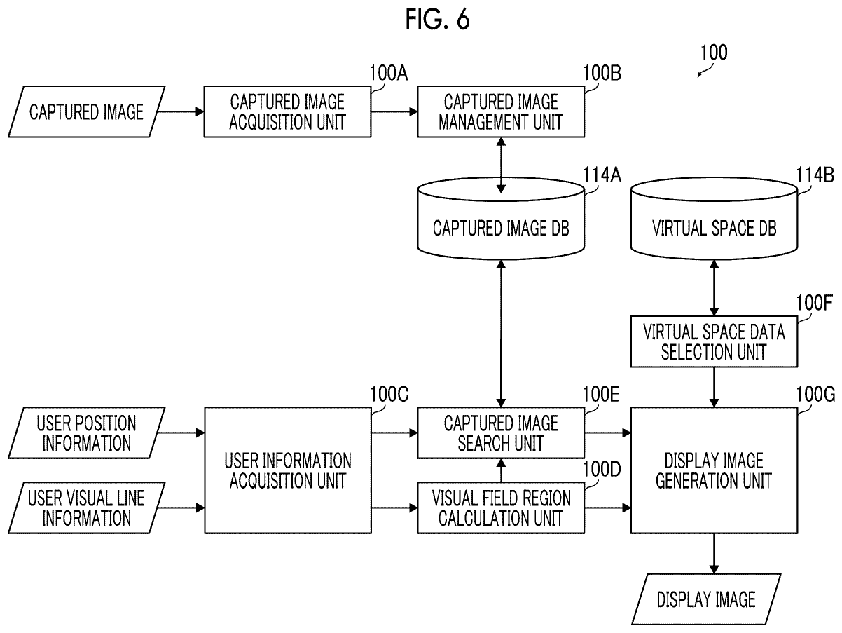

FIG. 6 is a block diagram of main functions of the image processing apparatus.

The image processing apparatus 100 mainly has a function of collecting the captured images from the image transmission terminal 200 and a function of providing the virtual space to the display terminal 10.

Regarding the function of collecting the captured images from the image transmission terminal 200, the image processing apparatus 100 functions as a captured image acquisition unit 100A and a captured image management unit 100B.

The captured image acquisition unit 100A acquires the captured image transmitted from the image transmission terminal 200 via the network 2.

The captured image management unit 100B stores the captured image acquired by the captured image acquisition unit 100A in a captured image database (DB) 114A. The captured image database 114A is stored in, for example, the auxiliary storage device 114. As described above, the information on the imaging position (imaging position information) is added to the captured image transmitted from the image transmission terminal 200. The captured image management unit 100B stores the captured image in the captured image database 114A in association with the imaging position information. In addition, the captured image management unit 100B numbers each captured image and stores the captured image in the captured image database 114A. A plurality of the captured images stored in the captured image database 114A are an example of an image captured in a real space.

Regarding the function of providing the virtual space to the display terminal 10, the image processing apparatus 100 functions as a user information acquisition unit 100C, a visual field region calculation unit 100D, a captured image search unit 100E, a virtual space data selection unit 100F, a display image generation unit 100G, and the like.

The user information acquisition unit 100C acquires information on a current state of the user (user information). The user information includes user position information (current position information of the user in the virtual space) and user visual line information (information on a current orientation of a visual line of the user in the virtual space). These pieces of information are acquired from the display terminal 10 through the network 2. The acquired information is added to the captured image search unit 100E and the visual field region calculation unit 100D. The user position information is an example of position information in a virtual space that reproduces a real space.

The visual field region calculation unit 100D calculates a visual field region (visual field) of the user in the virtual space based on the user information (user position information and user visual line information). More specifically, a visual field region of an avatar, which is an alter ego of the user in the virtual space, is calculated. This visual field region corresponds to a display range of the image of the virtual space displayed on the display unit 15. Information on the calculated visual field region (information on the display range) is added to the captured image search unit 100E and the display image generation unit 100G.

The captured image search unit 100E searches for a captured image (related image) related to the current position of the user from the captured image database 114A based on the current position information (user position information) of the user in the virtual space and the information on the current visual field region of the user.

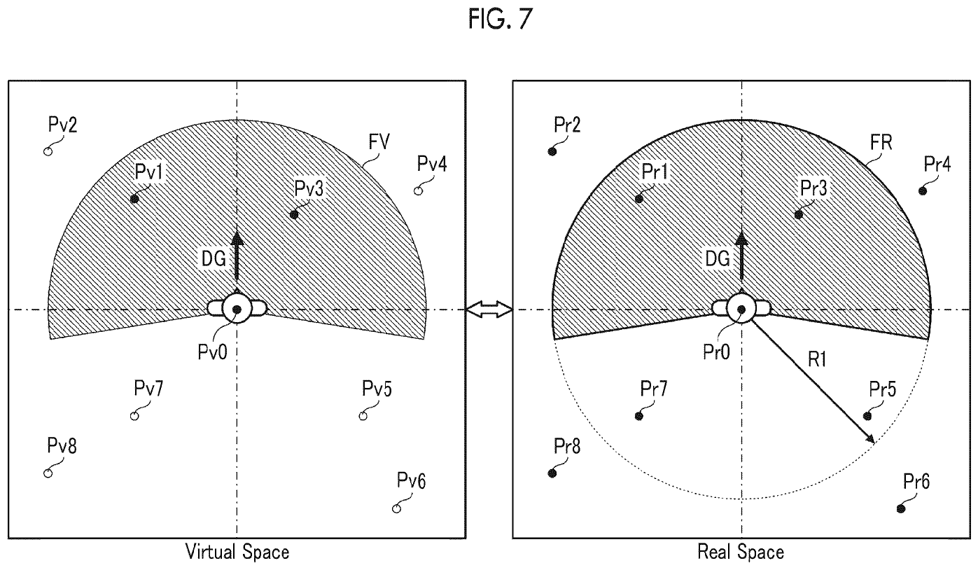

FIG. 7 is a conceptual diagram of the image search.

FIG. 7 is a plan view of a virtual space and a real space corresponding to the virtual space. Reference numeral Pv0 in FIG. 7 indicates a position of the user (avatar) in the virtual space. Reference numeral Pr0 indicates a position in the real space corresponding to the position Pv0 in the virtual space. Reference numeral Pr1 to reference numeral Pr8 indicate positions where images are captured in the real space (positions where images captured at the positions are present). Reference numeral Pv1 to reference numeral Pv8 indicate positions in the virtual space corresponding to the positions Pr1 to Pr8 in the real space. An arrow DG indicates a visual line direction of the user in the virtual space. A region FV indicated by a diagonal line indicates a region within a range of a radius R1 based on a current position Pv0 of the user in the virtual space and within a range of a visual field region (visual field) of the user. In this example, a range of 100° in a left-right direction (total of) 200° based on the visual line direction DG is set as a horizontal visual field region of the user in the virtual space. A region FR indicated by a diagonal line is a region in the real space corresponding to the region FV in the virtual space.

In the present embodiment, the captured image search unit 100E searches for an image that is captured within a range of the radius R1 (equal to or less than a distance threshold value R1) based on a position Pr0 in the real space corresponding to the current position Pv0 of the user in the virtual space and that is captured within a current visual field range. For example, in a case in which the current position of the user in the virtual space is latitude XX degrees XX minutes XX seconds North and longitude XX degrees XX minutes XX seconds East, and XX seconds, an image that is captured within a range of a circle of the radius R1 from a position at latitude XX degrees XX minutes XX seconds North and longitude XX degrees XX minutes XX seconds East and that is captured within the current visual field range is searched for (an image captured within a range of the region FR in the real space corresponding to the region FV in the virtual space is searched for). In the example shown in FIG. 7, the images captured at the positions Pr1, Pr3, Pr5, and Pr7 are images captured within a range of the radius R1. Among the images, the images captured at the positions Pr1 and Pr3 are images captured within a range corresponding to the current visual field range. Therefore, the images captured at the positions Pr1 and Pr3 are searched for.

The searched captured image is added to the display image generation unit 100G. The searched captured image is an example of a first image associated with the position information. In addition, the range of the radius R1 is an example of a range of a first distance.

In addition, the range of the region FR is an example of a range of the first distance from the position in the real space corresponding to the position information in the virtual space and a range in the real space corresponding to a range of a second image in the virtual space.

The virtual space data selection unit 100F selects virtual space data to be used. A plurality of the virtual space data are stored in advance in the virtual space database 114B. Therefore, the virtual space data selection unit 100F selects the virtual space data to be used from among the plurality of virtual space data stored in the virtual space database 114B. The virtual space database 114B is stored in, for example, the auxiliary storage device 114.

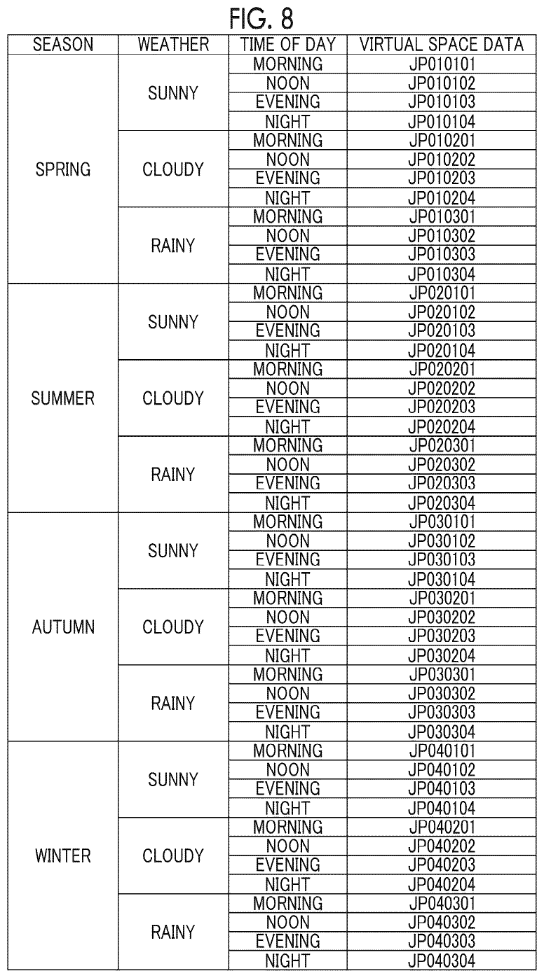

FIG. 8 is a diagram showing an example of the virtual space data stored in the virtual space database. FIG. 8 shows an example of virtual space data for providing a plurality of types of virtual spaces with different environments for one real space.

As shown in FIG. 8, a plurality of the virtual space data are prepared in combination of a season (spring, summer, autumn, and winter), weather (sunny, cloudy, and rainy), and time of day (morning, noon, evening, and night). Each virtual space data reproduces the same real space and differs in season, weather, and time of day.

As described above, the virtual space database 114B is configured to record a plurality of types of virtual space data for one real space, and to construct virtual spaces in different environments. The virtual space database 114B records virtual space data for reproducing at least one real space. Each virtual space data is recorded in association with information on the real space to be reproduced.

The real space to be reproduced (real space provided to the user as a virtual space) is selected by the user, for example. The virtual space data to be used is selected according to, for example, a current date and time of an area in which the display terminal 10 is used. In Japan, the season of the virtual space data to be used is selected based on the current date and time, with March to May as spring, June to August as summer, September to November as autumn, and December to February as winter. In addition, the time of day of the virtual space data to be used is selected based on the current date and time, with 6:00 to 9:00 as morning, 9:00 to 15:00 as noon, 15:00 to 18:00 as evening, and 18:00 to 6:00 next day as night. For example, in a case in which the area in which the display terminal 10 is used is Japan and the current date and time is 12:00 on January 1, the virtual space data corresponding to “noon” of “winter” is selected. As for the weather, weather set as a default (for example, sunny) is selected. Therefore, in this case, “JP040102” is selected as the virtual space data (in a case in which the default setting of “weather” is “sunny”). The weather may be configured to be randomly selected. Information on the current date and time is acquired from the system or the display terminal 10. The selected virtual space data is added to the display image generation unit 100G. In addition, predetermined virtual space data or virtual space data selected by the user may be selected.

The display image generation unit 100G generates an image (display image) of the virtual space to be provided to the display terminal 10 based on the virtual space data selected by the virtual space data selection unit 100F and the information on the visual field region calculated by the visual field region calculation unit 100D. The display image is an image of the virtual space observed from a viewpoint of the user at the current position of the user (avatar) in the virtual space.

In the present embodiment, in a case in which a captured image (related image) related to the current position of the user is present, the captured image is displayed in the virtual space. Therefore, in a case in which the captured image related to the current position of the user is present, the display image generation unit 100G generates a display image in which the captured image is displayed in the virtual space.

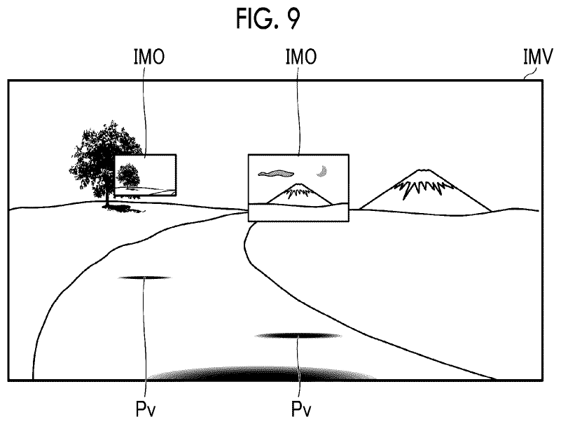

FIG. 9 is a diagram showing an example of an image of a virtual space displayed on the display unit of the display terminal.

An image (display image) IMV of the virtual space displayed on the display unit 15 of the display terminal 10 is an image obtained by cutting out a visual field region from an image of the virtual space constructed by the virtual space data.

In the present embodiment, a captured image IMO is displayed at a position Pv in the virtual space corresponding to an imaging position Pr in the real space. In addition, the captured image IMO is displayed in the virtual space at a predetermined size. That is, the captured image IMO is disposed in the virtual space as a planar object having a predetermined size and is visually recognized by the user. Therefore, the display size increases as the user approaches the display position (imaging position). In addition, the captured image IMO is displayed at a position at a predetermined height from a ground (for example, a position approximately at a visual line height of an adult). Therefore, the captured image IMO is displayed in a state of floating in the air in the virtual space. In addition, the captured image IMO is displayed facing the user (avatar). In the present embodiment, the captured image IMO displayed in the virtual space is an example of an object image.

The display image generated by the display image generation unit 100G is transmitted to the display terminal 10 through the network 2. The display terminal 10 receives the display image transmitted from the image processing apparatus 100 and displays the display image on the display unit 15. As a result, the user can view the image of the virtual space that changes in conjunction with the movement of the user. In the present embodiment, the display image is an example of a second image.

### [Operation of Image Processing Apparatus (Image Processing Method)]

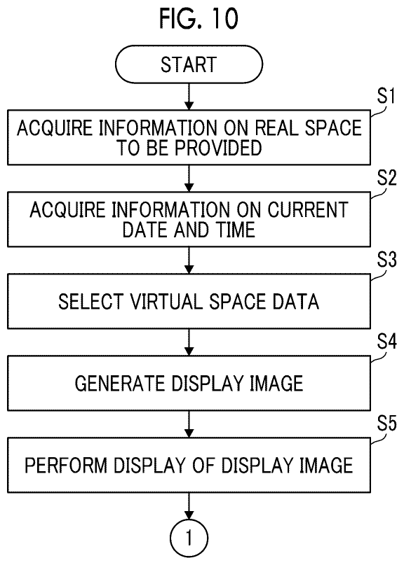

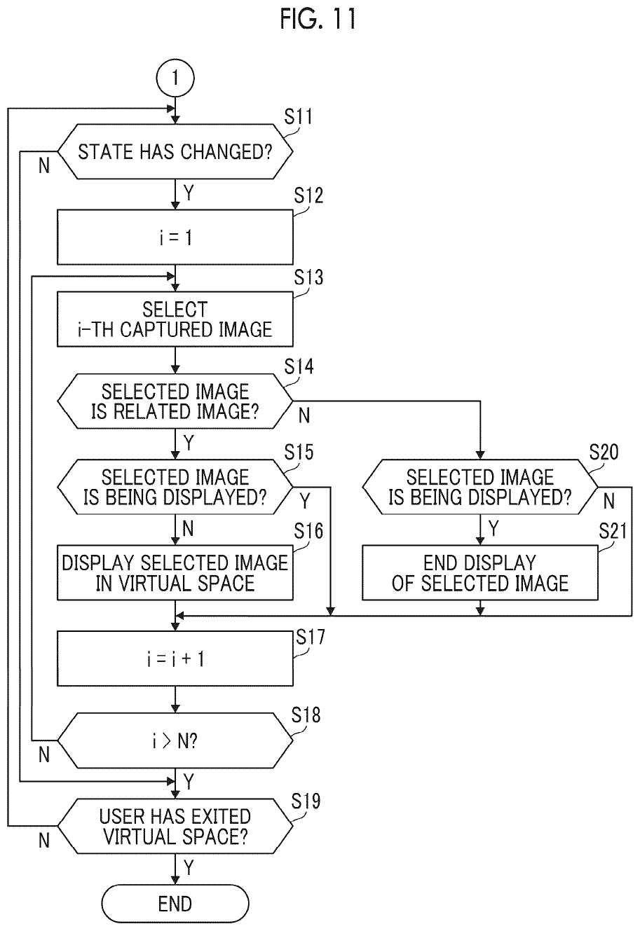

FIGS. 10 and 11 are flowcharts showing a procedure of providing a virtual space using the image processing apparatus. FIG. 10 shows a procedure leading to the display of the image of the virtual space on the display unit 15 of the display terminal 10. In addition, FIG. 11 shows an operation procedure after the start of the display.

As shown in FIG. 10, first, information on a real space to be provided is acquired (step S1). In the present embodiment, for example, information on a real space that can be provided as the virtual space is displayed in a list on the display unit 15 of the display terminal 10. The user selects a desired real space from the displayed list. The selected information is transmitted to the image processing apparatus 100 as the information on the real space to be provided.

Next, information on a current date and time is acquired (step S2). As described above, the information on the current date and time is acquired from the system or the display terminal 10.

Next, virtual space data of the virtual space to be provided is selected based on the acquired information on the real space and the acquired information on the current date and time (step S3). As described above, for example, in a case in which the current date and time is 12:00 on January 1, virtual space data corresponding to “noon” of “winter” is selected. As for the weather, weather set as a default is selected.

Next, a display image is generated based on the selected virtual space data (step S4). That is, an image of the virtual space to be displayed on the display unit 15 of the display terminal 10 is generated. This image is generated based on a reference position (origin position or start position) set in advance in the virtual space. In addition, the image is generated based on a reference visual line direction. That is, the image is generated as an image observed in a case of facing a predetermined direction at the reference position.

The generated display image is provided to the display terminal 10 through the network 2 and is displayed on the display unit 15 of the display terminal 10 (step S5).

In a case in which the display is started, as shown in FIG. 11, it is determined whether or not a state of the user has changed (step S11). That is, it is determined whether or not the user has moved or changed the direction of the visual line.

In a case in which a change in the state is detected, a captured image (related image) related to a current position of the user is searched for, and the searched related image is displayed in the virtual space. The related image is searched for from the captured image database 114A. The search and display are performed in the following procedure.

First, i is set to 1 (step S12), and an i-th captured image is selected as a processing target from the captured image database 114A (step S13).

Next, it is determined whether or not the selected captured image (selected image) is the related image (step S14). It is determined whether or not the image is captured within a range of a radius R1 based on a position in a real space corresponding to a current position of the user in the virtual space and is captured within a current visual field range. In this case, first, it is determined whether or not the selected image is an image captured within the range of the radius R1. In a case in which the image is not captured within the range of the radius R1, it is determined that the image is not the related image. On the other hand, in a case in which the image is captured within the range of the radius R1, it is then determined whether or not the image is an image captured within the current visual field range. In a case in which the image is not captured within the current visual field range, it is determined that the image is not the related image. On the other hand, in a case in which the image is captured within the current visual field range, it is determined that the image is the related image.

In a case in which it is determined that the selected image is the related image, it is determined whether or not the selected image is being displayed (step S15). That is, it is determined whether or not the selected image is already being displayed in the virtual space.

In a case in which the selected image is already being displayed, the display is continued. On the other hand, in a case in which the selected image is not being displayed, the selected image is displayed in the virtual space (step S16). The image is displayed at a position corresponding to the imaging position. That is, the virtual image is displayed at a position in the virtual space corresponding to the imaging position in the real space. In addition, the image is displayed in the virtual space at a predetermined size and is displayed facing the user (see FIG. 9).

In step S14, in a case in which it is determined that the selected image is not the related image, it is determined whether or not the selected image is being displayed (step S20). That is, it is determined whether or not the selected image is displayed in the virtual space even though the selected image is not the related image. In a case in which the selected image is being displayed, the display is ended (step S21).

Thereafter, a value of i is incremented as i=i+1 (step S17), and it is determined whether i has exceeded N (i>N) (step S18). That is, it is determined whether or not all the captured images in the captured image database 114A have been processed. N is the total number of the captured images in the captured image database 114A.

In a case in which i>N is not satisfied, that is, in a case in which there is a captured image to be processed next, the processing returns to step S13, and the processing is performed again.

On the other hand, in a case in which i>N, that is, in a case in which all the captured images in the captured image database 114A are processed, it is determined whether or not the user has exited the virtual space (step S19). For example, it is determined whether or not an instruction to end the display has been issued by turning off the power. In a case in which it is determined in step S11 that there is no change in state, it is also determined whether or not the user has exited the virtual space. In a case in which it is determined that the user has exited the virtual space, the processing is ended. On the other hand, in a case in which it is determined that the user has not exited the virtual space, the processing returns to step S11, and it is determined again whether or not there is a change in the state.

With the above-described configuration, in a case in which the user moves in the virtual space, the captured images are displayed in the virtual space one after another in conjunction with the movement. Each captured image is displayed at a position corresponding to a position in a real space where the image is captured. As a result, it is possible to present each captured image in a form that is easy to understand how the captured image is captured. In addition, the user can deepen the understanding of the captured image and can enjoy a better viewing experience. In addition, each captured image disappears in a case in which the user is separated from the display position (imaging position) by a distance equal to or greater than a certain distance, so that the display in the virtual space does not become cluttered.

### Modification Example

“Display of Image in Accordance with Imaging Direction”

In the above-described embodiment, in a case in which the captured image is displayed in the virtual space, a configuration is adopted in which the captured image is displayed in a state of facing the user. In a case in which information on the imaging direction can be acquired from the captured image, the captured image may be displayed in accordance with an orientation in which the captured image is captured.

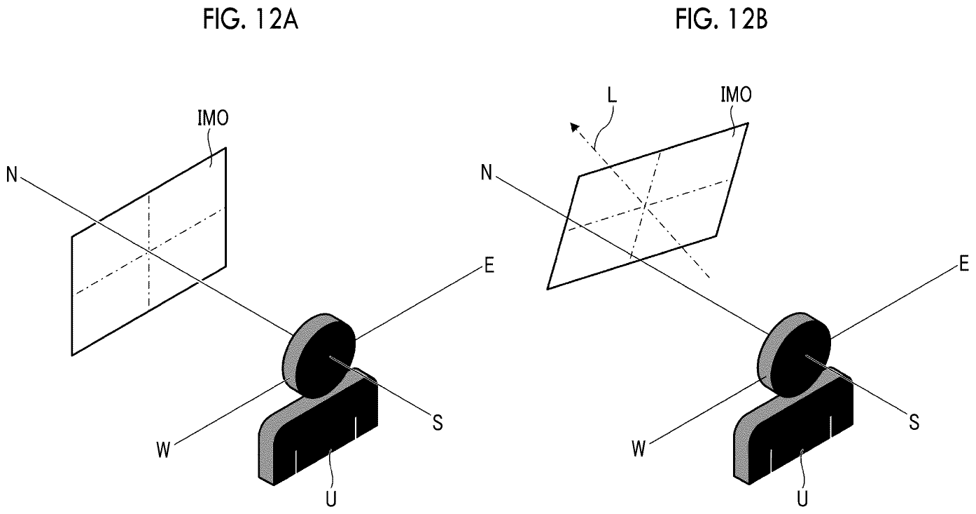

FIGS. 12A and 12B are conceptual diagrams of display of a captured image.

FIG. 12A is a conceptual diagram of display of the captured image IMO in a case in which the information on the imaging direction cannot be acquired from the captured image IMO. FIG. 12B is a conceptual diagram of display of the captured image IMO in a case in which the information on the imaging direction can be acquired from the captured image IMO.

As shown in FIG. 12A, in a case in which the information on the imaging direction cannot be acquired from the captured image IMO, the captured image IMO is displayed facing a user (avatar) U. More specifically, the captured image IMO is displayed perpendicular to a depth direction of the screen.

On the other hand, in a case in which the information on the imaging direction can be acquired from the captured image IMO, the captured image IMO is displayed in the virtual space in accordance with the imaging direction in a case in which the image is captured. Specifically, the captured image IMO is displayed perpendicular to an orientation of an optical axis L during imaging.

The information on the imaging direction is acquired from information (for example, tag information) attached to the captured image. In addition, the imaging direction may be estimated by image recognition.

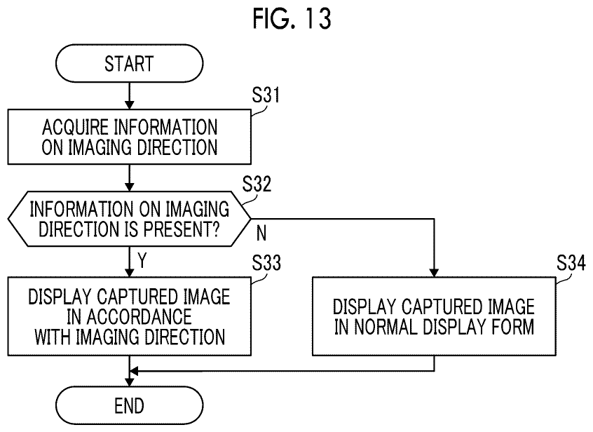

FIG. 13 is a flowchart showing a procedure of processing of displaying a captured image.

First, information on an imaging direction of a captured image to be displayed is acquired (step S31). As described above, the information on the imaging direction is acquired from information attached to the captured image. Alternatively, the information on the imaging direction is acquired by image recognition.

Next, it is determined whether or not the information on the imaging direction is present (step S32). That is, it is determined whether or not the information on the imaging direction can be acquired.

In a case in which the information on the imaging direction is present (in a case in which the information on the imaging direction can be acquired), the captured image is displayed in the virtual space in accordance with the direction in which imaging is performed (step S33). That is, as shown in FIG. 12B, the captured image IMO is displayed perpendicular to the imaging direction (the direction of the optical axis L).

On the other hand, in a case in which the information on the imaging direction is not present (in a case in which the information on the imaging direction cannot be acquired), the captured image is displayed in the virtual space in a normal display form (step S34). That is, as shown in FIG. 12A, the captured image IMO is displayed facing the user.

In this way, in a case in which the information on the imaging direction can be acquired, the captured image is displayed in the virtual space in accordance with the orientation in which imaging is performed. As a result, it is possible to more deeply understand how the captured image being displayed is captured.

In addition, in a case in which information on a height from a ground in a case in which the captured image is captured can be acquired, the captured image may be displayed in the virtual space in accordance with the height in a case in which the imaging is performed.

Some users may find the normal display form easier to view. Therefore, the user may be able to optionally select whether or not to display the image in accordance with the imaging direction.

[Display of Image in Accordance with Imaging Angle of View]

In the above-described embodiment, in a case in which the captured image is displayed in the virtual space, a configuration is adopted in which the captured image is displayed at a specified size set in advance. In a case in which information on an angle of view can be acquired from the captured image, the captured image may be displayed in the virtual space at a size corresponding to the angle of view.

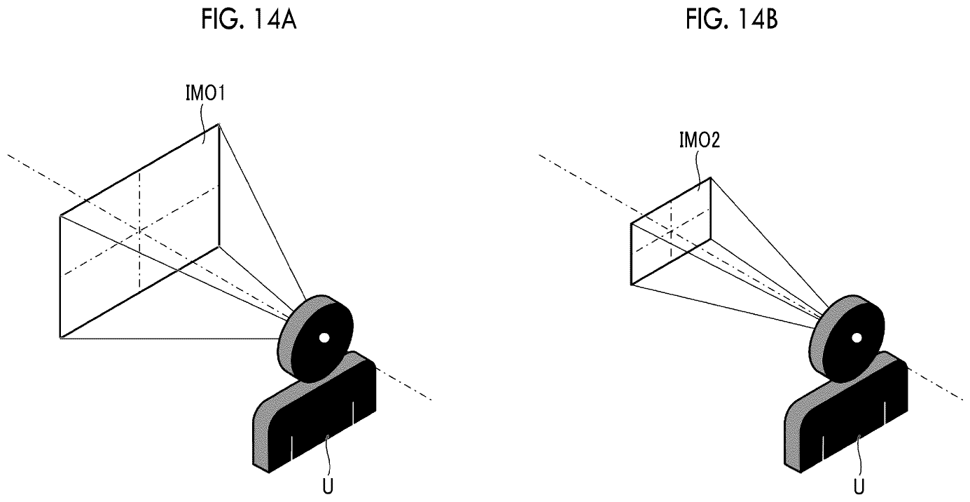

FIGS. 14A and 14B are conceptual diagrams of display of a captured image.

FIGS. 14A and 14B show display examples of two images captured at different angles of view. FIG. 14A shows an example of a case in which imaging is performed at a wider angle of view than in FIG. 14B. More specifically, in a case in which an angle of view of a captured image IMO1 shown in FIG. 14A is denoted by ω1 and an angle of view of a captured image IMO2 shown in FIG. 14B is denoted by ω2, an example of a case in which ω1>ω2 is shown.

As shown in FIGS. 14A and 14B, in a case of viewing the image from the same position, the captured image IMO1 captured at the wide angle of view ω1 is displayed in a larger size than the captured image IMO2 captured at the narrow angle of view ω2.

For images captured with cameras of the same sensor size, the shorter the focal length, the larger the angle of view. That is, an image captured with a wide angle lens has a wider (larger) angle of view, and an image captured with a telephoto lens has a narrower (smaller) angle of view.

In a case in which the information on the angle of view is attached to the captured image, the information on the angle of view of the captured image is directly acquired from the accessory information. In a case in which the information on the angle of view is not attached to the captured image, the information on the angle of view is acquired by using other information attached to the captured image. The angle of view can be calculated from the size of the image sensor and the focal length of the lens. In addition, for example, in a case in which the accessory information includes information on the focal length of the 35 mm equivalent lens, the angle of view can be calculated from the information. For example, in a case in which the focal length of the 35 mm equivalent lens is f=50 mm, the angle of view is approximately 47°. In this case, acquiring the information on the focal length of the 35 mm equivalent lens substantially means acquiring the information on the angle of view.

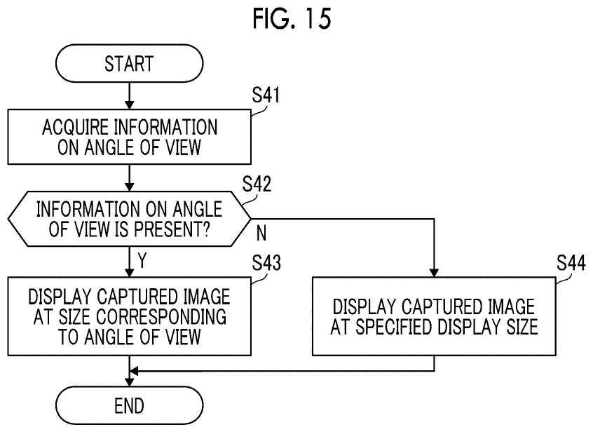

FIG. 15 is a flowchart showing a procedure of processing of displaying a captured image.

First, information on an angle of view of a captured image to be displayed is acquired (step S41). As described above, the information on the angle of view is acquired from information attached to the captured image. In this case, in a case in which the information on the angle of view cannot be directly acquired from the accessory information, the information on the angle of view is acquired by calculation.

Next, it is determined whether or not the information on the angle of view is present (step S42). That is, it is determined whether or not the information on the angle of view can be acquired.

In a case in which the information on the angle of view is present (in a case in which the information on the angle of view can be acquired), the captured image is displayed in the virtual space at a size corresponding to the angle of view (step S43).

On the other hand, in a case in which the information on the angle of view is not present (in a case in which the information on the angle of view cannot be acquired), the captured image is displayed in the virtual space at a specified display size (default display size) (step S44). That is, the captured image is displayed in the virtual space at a predetermined size.

In this way, in a case in which the information on the angle of view can be acquired, the captured image is displayed in the virtual space at a size corresponding to the angle of view. As a result, it is possible to understand the angle of view at which the captured image being displayed is captured, so that it is possible to correctly understand a size of a subject.

In a case in which the display size of the captured image is changed according to the angle of view as in this example, the display size may be too large or too small depending on the image. For example, an image captured with a super telephoto lens may appear too small in a case of being displayed. In addition, for example, an image captured with an ultra-wide angle lens (including a fisheye lens) may appear too large in a case of being displayed. Therefore, it is more preferable to impose a limit on the display size. For example, an image having an angle of view equal to or less than a threshold value (equal to or less than a limit value position) can be uniformly displayed at a specified size (minimum display size). Similarly, an image having an angle of view equal to or greater than the threshold value (equal to or greater than an upper limit value) can be uniformly displayed at a specified size (maximum display size).

In addition, some users may find it easier to view in a case in which all the images are displayed in the same size. Therefore, the user may be able to optionally select whether or not to change the display size depending on the angle of view.

As in the above modification example, the captured image may be displayed in accordance with the orientation in which imaging is performed. In this case, the captured image is displayed in accordance with the orientation in which imaging is performed, and the captured image is displayed at a size corresponding to the angle of view.

### [Environment Settings of Virtual Space]

In the above-described embodiment, a configuration is adopted in which an environment of the virtual space to be provided to the user is decided based on the information on the current date and time of the area in which the display terminal 10 is used, but the method of deciding the environment of the virtual space to be provided to the user is not limited to this. A virtual space with a predetermined environment may be provided to the user. In addition, a configuration may be adopted in which the user can optionally select and set the environment of the virtual space to be displayed. For example, the user may select and set all of the season, the weather, and the time of day of the virtual space to be provided.

### [Display of Captured Image in Virtual Space]

In the above-described embodiment, a configuration is adopted in which in a case in which the captured image (related image) related to the current position of the user is present in the virtual space, the captured image is displayed at the position corresponding to the imaging position, but the aspect in which the captured image is displayed in the virtual space is not limited to this.

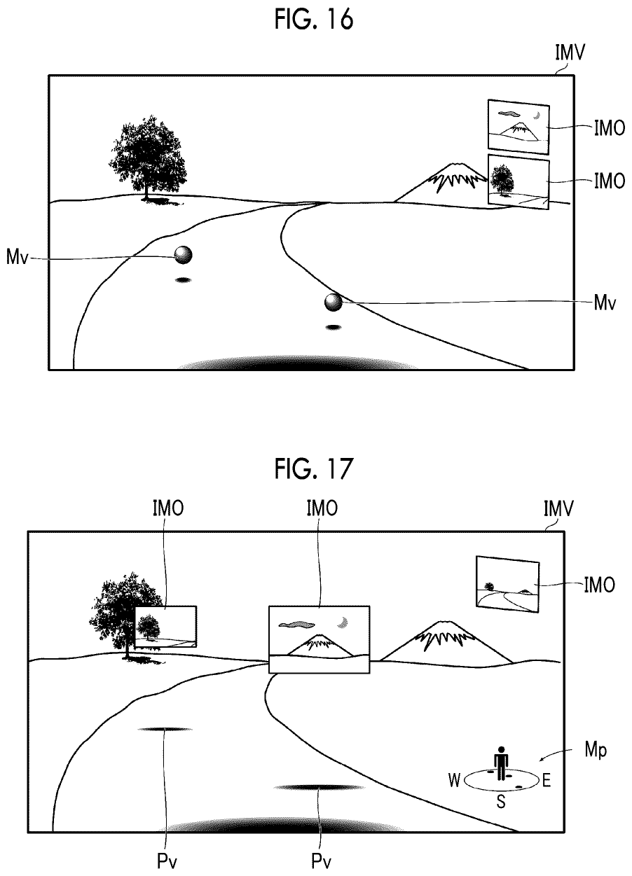

FIG. 16 is a diagram showing another example of display of a captured image.

FIG. 16 shows an example of a case in which, in a case in which related images are present, the related images are displayed together at a predetermined position in the virtual space. In the example shown in FIG. 16, an example of a case in which the captured images IMO are displayed in a vertical line on a right corner is shown. In this case, as shown in FIG. 16, a mark Mv may be displayed at a position in the virtual space corresponding to the imaging position of each captured image IMO to know the imaging position. In addition, in this case, each mark Mv may be displayed in a different color and the corresponding captured image IMO may be displayed in a frame of the same color so that the correspondence relationship between each captured image IMO and each mark Mv is understood.

FIG. 17 is a diagram showing still another example of display of a captured image.

FIG. 17 is an example of a case in which an image captured within the range of the radius R1 based on a position in the real space corresponding to the current position of the user in the virtual space is extracted as a related image and is displayed in the virtual space.

The image captured within the range of the current visual field is displayed in the virtual space corresponding to the imaging position. On the other hand, an image captured outside the range of the visual field is displayed in a predetermined region. In the example shown in FIG. 17, an example of a case in which the captured images IMO are displayed in a horizontal line on an upper corner is shown. In this case, as shown in FIG. 17, a map Mp may be displayed in the virtual space, and the approximate display position of each captured image may be indicated on the map Mp.

### Second Embodiment

In the image viewing system 1 of the above-described embodiment, in a case in which an image captured in the real space is present, in a case in which the user approaches an imaging position of the image in the virtual space, the captured image is displayed in the virtual space.

In the image viewing system 1 of the present embodiment, the virtual space is further changed in accordance with the captured image to be viewed by the user. For example, in a case in which the image to be viewed by the user is of the autumn season, the season of the virtual space is also changed to autumn.

The image appreciation system is the same as the image viewing system of the above-described embodiment except that the virtual space is changed. Therefore, only the differences will be described below.

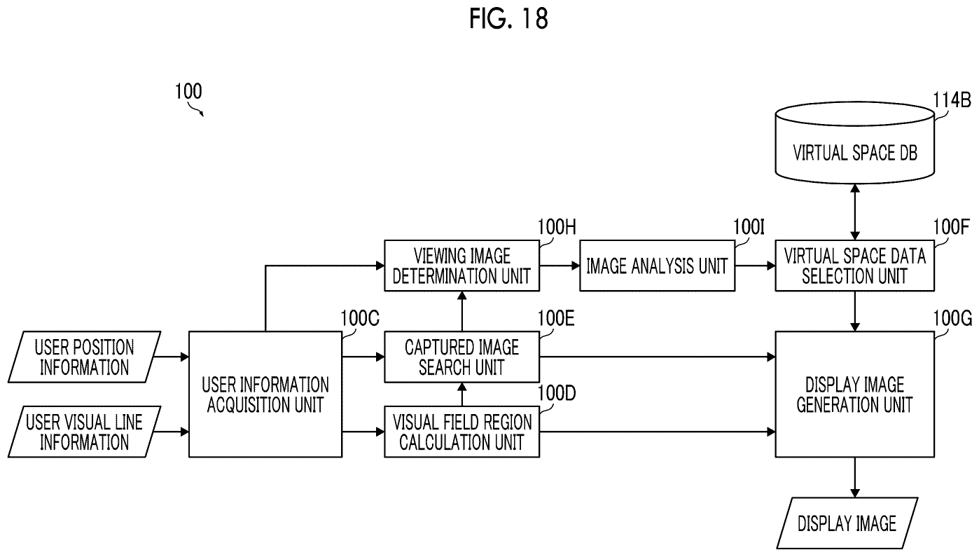

FIG. 18 is a block diagram of main functions of the image processing apparatus with respect to a change in the virtual space.

As shown in FIG. 18, the image processing apparatus 100 of the present embodiment further has functions of a viewing image determination unit 100H and an image analysis unit 100I.

The viewing image determination unit 100H determines a captured image being viewed by the user from among the captured images displayed in the virtual space. The viewing image determination unit 100H determines the captured image being viewed based on the current position information of the user (user position information) in the virtual space and the information on the captured image being displayed in the virtual space.

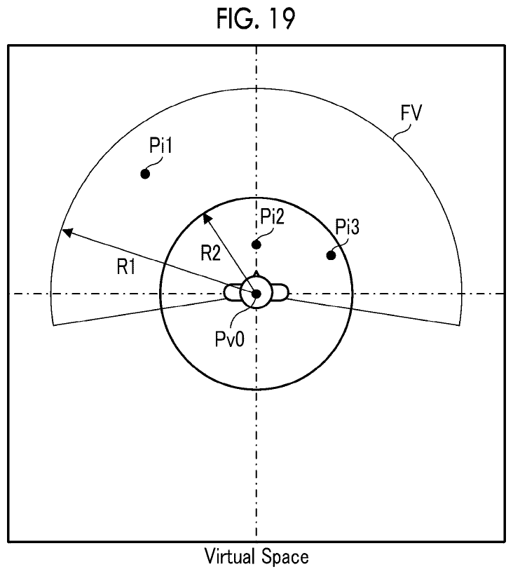

FIG. 19 is a conceptual diagram of determination of a captured image being viewed.

FIG. 19 is a plan view of the virtual space. Reference numeral Pv0 in FIG. 19 indicates a current position of the user (avatar) in the virtual space. Reference numeral Pi1 to reference numeral Pi3 indicate display positions of the captured images in the virtual space. The example shown in FIG. 19 is an example of a case in which three captured images are displayed in the virtual space.

In the present embodiment, an image located within a range of a radius R2 (equal to or less than a distance threshold value R2) based on the current position Pv0 of the user is regarded as the image being viewed by the user, and is extracted from the captured images being displayed. The radius R2 is set to a value smaller than the radius R1 (R2<R1). That is, in a case in which the user approaches the captured image displayed in the virtual space by a certain distance or more, the user is deemed to be viewing the image.

In a case in which a plurality of captured images are present within the range of the radius R2, among the plurality of displayed captured images, a captured image displayed at a position closest to the current position Pv0 of the user is regarded as the image being viewed by the user.

In the case of the example shown in FIG. 19, two captured images (the captured image at the position Pi2 and the captured image at the position Pi3) are displayed within the range of the radius R2. The position Pi2 is closer to the user than the position Pi3. Therefore, in this case, the captured image displayed at the position Pi2 is the captured image being viewed.

Information on the captured image determined to be under viewing is added to the image analysis unit 100I. In the present embodiment, the range of the radius R2 is an example of a range of a second distance.

The determination of the captured image being viewed is substantially synonymous with the determination of the captured image being selected by the user. That is, it is synonymous with determining the image selected to be viewed.

The image analysis unit 100I analyzes image information of the captured image. That is, the contents of what is being captured (so-called content) are analyzed. In particular, in the present embodiment, the image information is analyzed, and the imaging environment is determined. The imaging environment here is an environment of the real space where the image is captured. The imaging environment includes at least one of a season, weather, or a time of day. In the present embodiment, the season, the weather, and the time of day of the captured image are determined.

The analysis of the image information includes analysis of accessory information in addition to the image analysis. That is, analyzing the accessory information to determine the imaging environment is included. For the analysis of the image information through the image analysis, for example, a method of determining the imaging environment through image recognition is employed. In the present embodiment, the imaging environment is determined by analyzing the accessory information.

Here, the season, weather, and time of day of the captured image can be specified roughly from the imaging position and the imaging date and time. In addition, in a case in which an imaging location is Japan, the time of day can be specified from the imaging date and time by defining 6:00 to 9:00 as morning, 9:00 to 15:00 as noon, 15:00 to 18:00 as evening, and 18:00 to 6:00 next day as night. Similarly, in a case in which the imaging location is Japan, the season can be specified from the imaging date and time by defining March to May as spring, June to August as summer, September to November as autumn, and December to February as winter. The weather can be specified, for example, by referring to a database (weather database) that records past weather in various locations. Therefore, in a case in which the information on the imaging position and the imaging date and time is attached to the captured image, the imaging environment (season, weather, and time of day) of the captured image can be determined from the information.

The image analysis unit 100I analyzes information (for example, meta information) attached to the captured image and determines the imaging environment. Information on the determined imaging environment is added to the virtual space data selection unit 100F.

In a case in which the accessory information cannot be acquired, the imaging environment cannot be determined. In this case, it is considered that the imaging environment is undeterminable. In addition, in a case in which determination cannot be made for a part of items, the item is considered to be undeterminable (no information). For example, in a case in which the weather cannot be determined, it is considered that the weather is undeterminable.

The virtual space data selection unit 100F selects virtual space data to be used. As described above, a standard virtual space data is selected based on the current date and time of the area in which the display terminal 10 is used. On the other hand, in a case in which a captured image being viewed by the user is present, the virtual space data corresponding to the captured image being viewed is selected. The virtual space data selection unit 100F selects the virtual space data to be used based on the analysis result of the imaging environment of the captured image via the image analysis unit 100I. That is, the virtual space data to be used is selected based on the determined season, weather, and time of day of the captured image. The virtual space data selection unit 100F searches for the corresponding virtual space data from the virtual space database 114B and selects the virtual space data to be used. For example, in a case in which the season determined from the captured image is “spring”, the weather is “sunny”, and the time of day is “noon”, the virtual space data of “JP010102” is selected as shown in FIG. 8.

In a case in which the imaging environment cannot be determined for the captured image being viewed by the user, the virtual space is not changed. Therefore, in this case, the virtual space data is not selected.

In a case in which the imaging environment cannot be determined for a part of items (in a case in which there is no information), a search is performed for the item with a predetermined default setting. For example, in a case in which the “season” is undeterminable (in a case in which there is no information), the corresponding virtual space data is searched for using the information on the season (for example, “spring”) set as default for the “season”. The default setting may be configured to be optionally set by the user. In addition, the current setting is maintained for the undeterminable item. For example, in a case in which the “season” is undeterminable, the virtual space data may be searched for using the information on the season of the currently displayed virtual space.

The display image generation unit 100G generates an image (display image) of the virtual space to be provided to the display terminal 10 based on the virtual space data selected by the virtual space data selection unit 100F and the information on the visual field region calculated by the visual field region calculation unit 100D. In the present embodiment, in a case in which a captured image being viewed by the user is present, an image of the virtual space that matches an environment of the captured image is generated.

### [Operation of Image Viewing System]

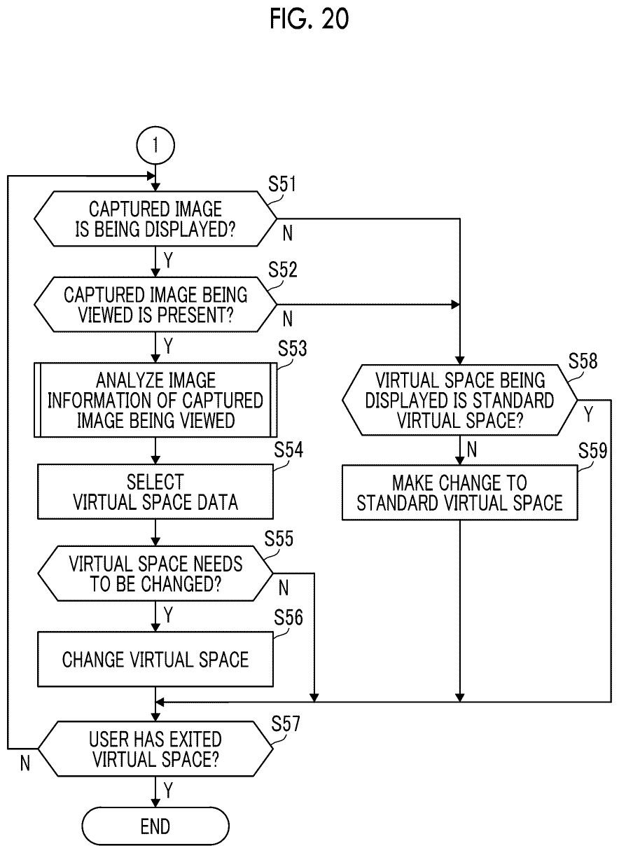

FIG. 20 is a flowchart of a procedure of processing related to a change in the virtual space.

First, it is determined whether or not a captured image being displayed is present (step S51). That is, it is determined whether or not the captured image being displayed is present in the virtual space being currently displayed.

In a case in which the captured image being displayed is present, it is determined whether or not a captured image being viewed is present (step S52). In the present embodiment, the presence or absence of the captured image being viewed is determined by determining the presence or absence of the image within the range of the radius R2 with respect to the current position of the user.

In a case in which a plurality of captured images are present within the range of the radius R2, a captured image closest to the current position of the user is the captured image being viewed.

In a case in which the captured image being viewed is present, image information of the captured image being viewed is analyzed (step S53). In the present embodiment, an imaging environment is determined by analyzing accessory information of the captured image being viewed.

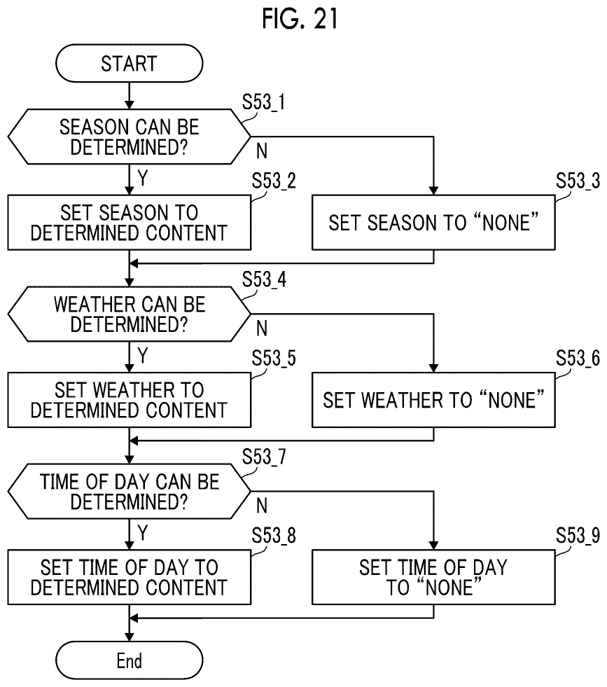

FIG. 21 is a flowchart showing a procedure of imaging environment determination processing.

First, it is determined whether or not the season can be determined (step S53_1). In the present embodiment, it is determined whether or not the season can be determined depending on the presence or absence of the information on the imaging position and the imaging date and time. In a case in which the information on the imaging position and the imaging date and time can be acquired, it is determined that the season is determinable.

In a case in which the season is determinable, data of the season is set to the determined content (step S53_2). On the other hand, in a case in which the season is undeterminable, the season data is set to “none” (step S53_3).

Next, it is determined whether or not the weather can be determined (step S53_4). In the present embodiment, it is determined whether or not the weather can be determined depending on the presence or absence of the information on the imaging position and the imaging date and time. In a case in which the information on the imaging position and the imaging date and time can be acquired, it is determined that the weather is determinable. As described above, the weather is determined from the imaging position and the imaging date and time by referring to the weather database.

In a case in which the weather is determinable, data of the weather is set to the determined content (step S53_5). On the other hand, in a case in which the weather is undeterminable, the weather data is set to “none” (step S53_6).

Next, it is determined whether or not the time of day can be determined (step S53_7). In the present embodiment, it is determined whether or not the time of day can be determined depending on the presence or absence of the information on the imaging date and time.

In a case in which the time of day is determinable, data of the time of day is set to the determined content (step S53_8). On the other hand, in a case in which the time of day is undeterminable, the time-of-day data is set to “none” (step S53_9).

In the above-described series of steps, the imaging environment of the captured image being observed is determined. The virtual space data is selected based on the determined imaging environment (step S54). That is, based on the set data of season, weather, and time of day, the corresponding virtual space data is searched for from virtual space database 114B, and the virtual space data of the virtual space to be changed is selected. For example, in a case in which the data of the season is set to “spring”, the data of the weather is set to “sunny”, and the data of the time of day is set to “noon”, as shown in FIG. 8, the virtual space data of “JP010102” is selected. For the item in which the data is “none”, data set as default is used. For example, in a case in which the data of the season is “spring”, the data of the weather is “none”, and the data of the time of day is “noon”, the virtual space data is searched for with the data of the weather set as the default (for example, “sunny”).

In a case in which the virtual space data to be changed is selected, as shown in FIG. 20, it is determined whether or not the virtual space needs to be changed (step S55). In a case in which the selected virtual space data is the same as the virtual space data of the currently provided virtual space, it is determined that the change is not necessary. In this case, the virtual space is not changed, and the current display is continued. On the other hand, in a case in which the selected virtual space data is different from the virtual space data of the currently provided virtual space, it is determined that the change is necessary.

In a case in which it is determined that the change of the virtual space is necessary, the virtual space to be provided is changed (step S56). In this case, an image (display image) of the virtual space to be provided to the display terminal 10 is generated based on the selected virtual space data, and is provided to the display terminal 10. The image of the virtual space to be provided is an image that reproduces an environment of the image being viewed by the user. As a result, a sense of realism can be improved.

Thereafter, it is determined whether or not the user has exited the virtual space (step S57). In a case in which it is determined that the user has exited the virtual space, the processing is ended. On the other hand, in a case in which it is determined that the user has not exited the virtual space, the processing returns to step S51, and the processes of step S51 and subsequent steps are performed again.

In addition, in a case in which it is determined in step S51 that the captured image being displayed is not present, and in a case in which it is determined in step S52 that the captured image being viewed is not present, it is determined whether or not the virtual space being displayed is a standard virtual space (step S58). Here, the standard virtual space is an environment of the virtual space in a case in which the display is started. As described above, in the present embodiment, the virtual space to be provided is set based on the information on the current date and time of the area in which the display terminal 10 is used. Therefore, it is determined whether or not the image of the virtual space being displayed is the image of the virtual space set based on the current date and time of the use area.

In a case in which the image of the virtual space being displayed is not the standard virtual space, the virtual space is changed to the standard virtual space (step S59). Therefore, in a case in which the user stops viewing the captured image displayed in the virtual space (in a case in which the user moves away from the captured image being viewed by the distance threshold value R2 or greater), the virtual space is restored to the standard virtual space.

As described above, with the image viewing system of the present embodiment, in a case in which the image captured in the real space is present, in a case in which the user approaches the imaging position of the captured image, the captured image is displayed at the imaging position. In a case in which the user approaches the displayed captured image, the display is switched to display of the virtual space corresponding to the imaging environment of the captured image. In other words, the display switches to a virtual space that reproduces the environment in which the image is captured.

In addition, in a case in which the user moves away the captured image being viewed, the environment of the virtual space is restored to the original environment. Further, in a case in which the user moves away, the display of the captured image is erased.

As described above, according to the present embodiment, the virtual space to be provided is changed in accordance with the captured image being viewed. As a result, the sense of realism in viewing the captured image can be improved. Therefore, a better viewing experience can be enjoyed.

### Modification Example

### [Determination of Imaging Environment]

As described above, the determination of the imaging environment can also be performed by image recognition. In this case, for example, a configuration can be adopted in which the imaging environment is determined using a trained model that has been trained through machine learning to determine the imaging environment from an image.

In addition, a configuration can also be adopted in which the imaging environment of the captured image is determined by using both the determination of the imaging environment through image recognition and the determination of the imaging environment through analysis of the accessory information.

In addition, in the above-described embodiment, the season, the weather, and the time of day are determined as the imaging environment, but the information to be determined as the imaging environment is not limited to this. For example, a wind direction or a wind speed may be determined. In addition, each item may be determined by further detailed classification.

### [Change of Virtual Space]

In the above-described embodiment, the environment of the virtual space is changed by switching the virtual space data to be used, but the method of changing the virtual space is not limited to this. In addition, for example, a configuration can be adopted in which the environment of the virtual space is changed by processing the image of the virtual space to be provided. For example, a configuration can be adopted in which an effect is added to the image to change the environment of the virtual space. For example, a configuration can be adopted in which a plurality of effects corresponding to typical weather are prepared in advance, and an effect of weather corresponding to the weather of the captured image being viewed is added to the image of the virtual space to change the weather of the virtual space. The effect itself is a known technology, so that detailed description thereof will be omitted. For example, an effect can be added to the image by filter processing.

In addition, a configuration can be adopted in which the environment of the virtual space to be provided is changed by switching the virtual space data to be used in combination with effects. For example, a configuration can be adopted in which the season is handled by switching the virtual space data and the time of day and the weather are handled by the effect.

[Method of Determining Image being Viewed]

### [Determination Based on Visual Line]

In the above-described embodiment, the captured image displayed at a position closest to the user is regarded as the image being viewed, but the method of determining the image being viewed is not limited to this. For example, a captured image that is in the user's visual line may be regarded as the image being viewed and detected.

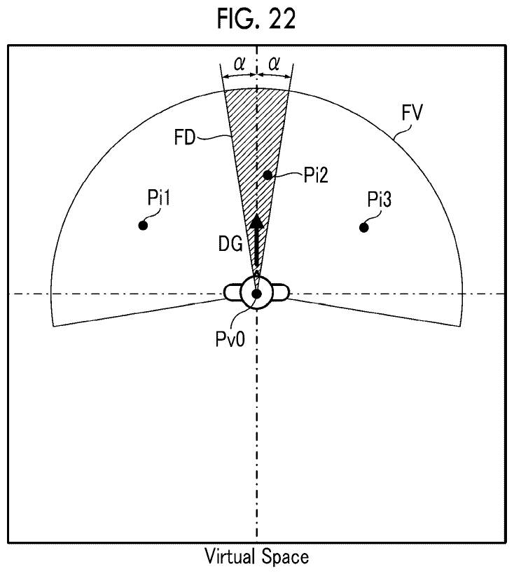

FIG. 22 is a conceptual diagram of determination of a captured image being viewed.

FIG. 22 is a plan view of the virtual space. Reference numeral Pv0 in FIG. 22 indicates a current position of the user (avatar) in the virtual space. An arrow DG indicates a visual line direction of the user in the virtual space. A region FD indicated by a diagonal line indicates a gaze region of the user. That is, it indicates a region where the user is gazing and paying attention. In this example, a gaze region FD is a range of an angle of ±α° in a horizontal direction based on the visual line direction DG. Reference numeral Pi1 to reference numeral Pi3 indicate display positions of the captured images in the virtual space. The example shown in FIG. 22 is an example of a case in which three captured images are displayed in the virtual space.

In this example, the image located in the gaze region FD is regarded as the image being viewed by the user, and is extracted from the captured images being displayed. In the example shown in FIG. 22, the captured image displayed at the position Pi2 is the captured image being viewed.

In a case in which a plurality of captured images are present within the range of the radius R2, the captured image displayed at the position closest to the current position Pv0 of the user is regarded as the image being viewed by the user.

As described above, the captured image that is in the user's visual line can be extracted and used as the image being viewed.

In this example, the image in the gaze region FD (image to which the user is gazing) is regarded as the image being viewed, but the image being viewed may be determined by limiting the image to an image located within a predetermined range from the current position of the user. That is, a configuration may be adopted in which an image that is present in the visual line direction of the user and that is present within a predetermined distance range is regarded as the image being viewed.

### [Determination Based on Selection Operation of User]

A configuration can also be adopted in which the image being viewed is determined based on a selection operation of the user. That is, a configuration can be adopted in which the image selected by the operation of the user is determined to be the image being viewed.

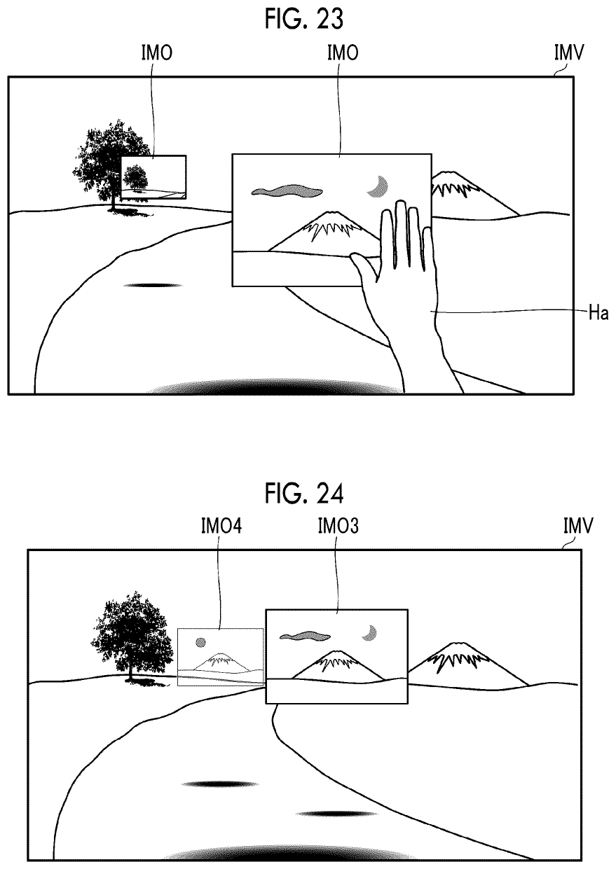

FIG. 23 is a diagram showing an example of an image selection operation of the user.

FIG. 23 is an example of a case in which a hand Ha of an avatar that is an alter ego of the user is displayed in the virtual space and an image is selected with the hand Ha. The user performs image selection by touching the captured image IMO displayed in the virtual space with the hand Ha.

In this case, in a case in which the user touches the captured image IMO with the hand Ha, the virtual space changes to a virtual space corresponding to the captured image IMO. In a case in which the user touches the captured image IMO with the hand Ha again, the virtual space changes to the original environment. Alternatively, in a case in which the user moves away from the selected captured image by a certain distance, the virtual space changes to the original environment. Alternatively, in a case in which another captured image is selected, the virtual space changes to a virtual space corresponding to the newly selected captured image.

In addition, in this case, the image being viewed may be made operable by the hand Ha displayed in the virtual space. For example, the displayed image may be enlarged and reduced by performing a pinch-out and pinch-in operation (gesture) on the image.

### [Display of Captured Image]

FIG. 24 is a diagram showing another example of display of a captured image in the virtual space.

FIG. 24 shows an example of a case in which two captured images IMO3 and IMO4 are present in relation to the current position of the user. The captured image IMO3 on one side is an image being viewed, and the captured image IMO4 on the other side is an image not being viewed.

As shown in FIG. 24, in this example, the captured image IMO3 being viewed and the captured image IMO4 not being viewed are displayed in different display aspects. In particular, in the example shown in FIG. 24, an example of a case in which an image other than the captured image being viewed is displayed in a semi-translucent state is shown (the captured image IMO4 is displayed in a semi-translucent state).

In this way, the captured image IMO3 being viewed and the captured image IMO4 not being viewed are displayed in different display aspects, so that it is possible to easily distinguish the captured image being viewed. In particular, as shown in FIG. 24, the image other than the captured image being viewed is displayed in a semi-translucent state, so that it is possible to more easily view the image being viewed.

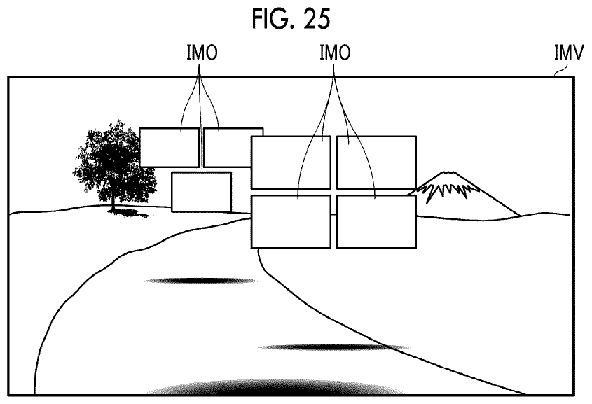

FIG. 25 is a diagram showing still another example of display of a captured image in the virtual space.

In a case in which a plurality of captured images are displayed, a configuration can be adopted in which the captured images are grouped according to the contents of what is being captured (content) and displayed for each group.

FIG. 25 is an example in which images in the same imaging environment are grouped. An example of classification into two groups is shown.

In this case, a position where the image is displayed can be, for example, an imaging position of an image representing each group. The image representing each group is, for example, an image with the most recent imaging date and time, an image with the oldest imaging date and time, or an image that has been viewed the most times. These may be set by the user as desired.

By collectively displaying the images in the same or similar imaging environment in this manner, frequent changes in the virtual space can be suppressed.

### Other Embodiments

### [Analysis of Image Information]

The image information of the captured image may be analyzed to determine an era in which the captured image is captured, and the virtual space may be changed to a virtual space that corresponds to the era in which the captured image is captured. As described above, various types of information can be acquired from the image, and the virtual space can be changed based on the acquired information. In addition, as described above, the method of analyzing the image is not particularly limited, and various methods can be employed.

In addition, in a case in which the display terminal 10 has a voice output function, a voice corresponding to the image information of the captured image may be output. For example, background music (BGM) corresponding to the contents of what is being captured may be output. For example, in a case in which a river is reflected in the image being viewed, a babbling sound of the river can be output. In addition, for example, the BGM may be prepared for each virtual space data and the BGM may be changed in conjunction with the change of the virtual space.

### [Display Terminal]

In the above-described embodiment, a case in which the display terminal 10 is configured as the HMD has been described as an example, but the configuration of the display terminal is not limited to this. The image of the virtual space may be presented on a non-wearable display such as a flat panel display.

In addition, the operation on the display terminal 10 may be performed by a gesture, a voice input, or the like in addition to the configuration in which the operation is performed by using a controller.

### [System Configuration]

In the above-described embodiment, the configuration is adopted in which the image processing apparatus 100 is disposed on the network, but the configuration of the image processing apparatus 100 is not limited to this. For example, a configuration may be adopted in which the image processing apparatus 100 is directly connected to the display terminal 10 in a wired or wireless manner. In addition, the display terminal 10 may have the functions of the image processing apparatus 100.

### [Collection of Captured Images]

In the above-described embodiment, the captured images are collected from a plurality of the image transmission terminals 200 through the network 2, but the method of collecting or acquiring the captured images is not limited to this. A configuration can also be adopted in which an image posted on SNS or the like is acquired.

### [Captured Image]

The captured image is not limited to a so-called still image, and also includes a video. In a case of the video, the imaging position is determined using the accessory information in the same manner as the still image, and the video is displayed at a position corresponding to the determined imaging position. In addition, in a case of the video, for example, an image of a first frame is displayed. In addition, in a case of the video, a configuration can be adopted in which the reproduction is started in a case in which it is determined that the video is being viewed. The determination as to whether or not the video is being viewed is made in the same manner as in a case of the still image. In addition, in a case of the video, for example, a configuration can be adopted in which the virtual space is changed simultaneously (or nearly substantially) with the start of the reproduction of the image, and the virtual space may be restored to the original space at the end of the reproduction.

In addition, in a case in which both the still image and the video are displayed in the virtual space as the captured image related to the current position of the user, it is preferable to display both the still image and the video in a distinguishable manner. For example, the video can be distinguished by displaying the video with a predetermined mark. In addition, preview reproduction or digest reproduction can be performed. The preview reproduction is a function of reproducing the first few seconds. The digest reproduction is a function of reproducing the video in a shortened manner.

### [Hardware Configuration of Image Processing Apparatus]

The functions of the image processing apparatus are implemented by various processors. The various processors include a CPU and/or a graphic processing unit (GPU), which is a general-purpose processor that executes program and functions as the various processing units, a programmable logic device (PLD), which is a processor of which a circuit configuration can be changed after manufacture, such as a field programmable gate array (FPGA), and a dedicated electric circuit, which is a processor having a circuit configuration that is designed for exclusive use in order to execute specific processing, such as an application specific integrated circuit (ASIC). The program is synonymous with software.

One processing unit may be configured by one of these various processors or may be composed of two or more processors of the same type or different types. For example, one processing unit may be configured by a combination of a plurality of FPGAs or a combination of a CPU and an FPGA. A plurality of processing units may be configured by one processor. As an example in which the plurality of processing units are configured by one processor, first, as represented by a computer used for a client or a server, one processor is configured by a combination of one or more CPUs and software and this processor functions as the plurality of processing units. Second, as represented by a system on chip (SoC), a processor that realizes the functions of the entire system including the plurality of processing units by using one integrated circuit (IC) chip is used. As described above, the various processing units are configured using one or more of the various processors as a hardware structure.

### EXPLANATION OF REFERENCES

1: image viewing system
2: network
10: display terminal
11: control unit
11A: position recognition unit
11B: visual line direction recognition unit
11C: communication control unit
11D: display control unit
12: communication unit
13: operation unit
14: sensor unit
15: display unit
16: voice input unit
17: voice output unit
100: image processing apparatus
100A: captured image acquisition unit
100B: captured image management unit
100C: user information acquisition unit
100D: visual field region calculation unit
100E: captured image search unit
100F: virtual space data selection unit
100G: display image generation unit
100H: viewing image determination unit
100I: image analysis unit
111: CPU
112: ROM
113: RAM
114: auxiliary storage device
114A: captured image database
114B: virtual space database
115: input device
116: output device
117: communication interface
200: image transmission terminal
DG: visual line direction
FD: gaze region
FV: region in virtual space
FR: region in real space corresponding to region FV
IMO: captured image
IMO1: captured image
IMO2: captured image
IMO3: captured image
IMO4: captured image
IMV: image of virtual space (display image)
L: optical axis
Mp: map
Mv: mark indicating imaging position
Pr: imaging position
Pv0: current position
U: user (avatar)
Ha: hand of user (avatar)
S1 to S5: procedure of providing virtual space
S11 to S21: procedure of providing virtual space
S31 to S34: procedure of processing of displaying captured image
S41 to S44: procedure of processing of displaying captured image
S51 to S59: procedure of processing related to change in virtual space

What is claimed is:

1. An image processing apparatus comprising:
a processor,
wherein the processor is configured to
decide an environment of a virtual space to be provided,
construct the virtual space that reproduces a real space using the determined environment,
acquire position information in the virtual space that reproduces the real space,
cause to display, based on a first image associated with the position information and captured in the real space, an object image representing the first image in the virtual space,
make a change to the virtual space corresponding to image information of the first image, and
cause to display a second image of the virtual space observed from a viewpoint corresponding to the position information on a display unit.

2. The image processing apparatus according to claim 1,
wherein the processor is configured to determine the environment of the virtual space to be provided based on a current date and time.

3. The image processing apparatus according to claim 1,
wherein the processor is configured to receive selection of the environment of the virtual space to be provided, to determine the environment of the virtual space to be provided.

4. The image processing apparatus according to claim 3,
wherein the processor is configured to receive selection of at least one of a season, weather, or time of day.

5. The image processing apparatus according to claim 1,
wherein the first image is an image captured within a range of a first distance from a position in the real space corresponding to the position information in the virtual space.

6. The image processing apparatus according to claim 5,
wherein the first image is further an image captured within a range in the real space corresponding to a range of the second image in the virtual space.

7. The image processing apparatus according to claim 1,
wherein the processor is configured to display the object image at a position in the virtual space corresponding to a position in the real space where the first image is captured.

8. The image processing apparatus according to claim 1,
wherein the processor is configured to make a change to the virtual space corresponding to the image information of the first image in a case in which a position indicated by the position information is moved to a position within a range of a second distance from a display position of the object image.

9. The image processing apparatus according to claim 1,
wherein the processor is configured to display the object image in an orientation in which the first image is captured.

10. The image processing apparatus according to claim 1,
wherein the processor is configured to display the object image at a size corresponding to an angle of view of the first image.

11. The image processing apparatus according to claim 10,
wherein the processor is configured to
in a case in which the angle of view of the first image exceeds a threshold value, display the object image at a size corresponding to the angle of view, and
display the object image at a specified size in a case in which the angle of view of the first image is equal to or less than the threshold value.

12. The image processing apparatus according to claim 1,
wherein the processor is configured to
determine an imaging environment of the first image based on the image information of the first image, and
make a change to the virtual space corresponding to the determined imaging environment.

13. The image processing apparatus according to claim 12,
wherein the processor is configured to determine at least one of a season, weather, or time of day as the imaging environment.

14. The image processing apparatus according to claim 1,
wherein the processor is configured to make a change to virtual space data for constructing a different virtual space.

15. The image processing apparatus according to claim 1,
wherein the processor is configured to apply an effect to change the virtual space.

16. The image processing apparatus according to claim 1,
wherein the processor is configured to
display a plurality of the object images in the virtual space in a case in which a plurality of the first images are present,
receive selection of the object image, and
make a change to the virtual space corresponding to the image information of the first image represented by the selected object image.

17. The image processing apparatus according to claim 16,
wherein the processor is configured to receive the selection of the object image by regarding the object image present in a visual line direction as the selected object image.

18. The image processing apparatus according to claim 16,
wherein the first image is an image captured within a range of a first distance from a position in the real space corresponding to the position information in the virtual space.

19. The image processing apparatus according to claim 18,
wherein the first image is further an image captured within a range in the real space corresponding to a range of the second image in the virtual space.

20. The image processing apparatus according to claim 16,
wherein the processor is configured to display the object image being selected and the other object image in different display aspects.

21. An image processing method comprising:
deciding an environment of a virtual space to be provided;
constructing the virtual space that reproduces a real space using the determined environment;
acquiring position information in the virtual space;
displaying, based on a first image associated with the position information and captured in the real space, an object image representing the first image in the virtual space;
making a change to the virtual space corresponding to image information of the first image, and
displaying a second image of the virtual space observed from a viewpoint corresponding to the position information on a display unit.

22. A non-transitory, computer-readable tangible recording medium on which a program for causing, when read by a computer, the computer to execute the image processing method according to claim 21 is recorded.
